(19) United States
(12) Patent Application Publication
(10) Pub. No.: US 2013/0092298 A1
(43) Pub. Date: Apr. 18, 2013

(54) METHODS OF FABRICATING A REFRACTORY-METAL ARTICLE, AND APPARATUSES FOR USE IN SUCH METHODS

(71) Applicants: Rainer Bregulla, Balingen (DE); Armin Stopper, Haigerloch (DE)

(72) Inventors: Rainer Bregulla, Balingen (DE); Armin Stopper, Haigerloch (DE)

(73) Assignee: ABBOTT CARDIOVASCULAR SYSTEMS, INC, Santa Clara, CA (US)

(21) Appl. No.: 13/271,831

(22) Filed: Oct. 12, 2011

(51) Int. Cl. B23K 26/00; C22F 1/00; B24B 1/00; C23F 1/02

(52) U.S. Cl. 148/565; 216/109; 148/559; 219/121.72; 451/28

(57) ABSTRACT

Embodiments of methods for fabricating refractory-metal articles (e.g., implantable medical devices), and honing and blasting apparatuses for use in such methods are disclosed. Methods for fabricating refractory-metal-containing articles include laser cutting in a vacuum environment and/or at least one mechanical or chemical finishing step configured to remove at least one region affected by the fabrication process (e.g., the laser cutting process) to provide a substantially defect-free surface finish.

### BACKGROUND

Stents, grafts and a variety of other implantable devices are well known and used in interventional procedures, such as for treating aneurysms, for lining or repairing vessel walls, for filtering or controlling fluid flow, and for expanding or scaffolding occluded or collapsed vessels. Such implantable devices can be delivered and used in virtually any accessible body lumen of a human or an animal, and can be deployed by any of a variety of recognized means.

Implantable devices, such as stents, are used for the treatment of atherosclerotic stenosis in blood vessels. For example, after a patient undergoes a percutaneous transluminal coronary angioplasty or similar interventional procedure, an implantable device, such as a stent, is often deployed at the treatment site to improve the results of the medical procedure and to reduce the likelihood of restenosis. The implantable device is configured to scaffold or support the treated blood vessel. If desired, the implantable device can also be loaded with a beneficial agent or agents to act as a delivery platform to reduce restenosis or the like.

Factors affecting the choice of the medical implant or device and the material thereof are mainly mechanical properties and biocompatibility. For example, the implantable device should have sufficient rigidity, flexibility, and biocompatibility. In addition, it is preferred that the implantable device be visible under x-rays and the implantable device should not interfere with MRI analysis. Refractory metals and refractory-metal alloys are well-suited for fabricating implantable devices because they have favorable mechanical properties, x-ray and MRI properties, and excellent biocompatibility. Moreover, refractory metals and refractory-metal alloys can be made sufficiently radio-opaque to allow for good imaging of the device under x-ray without the addition of an extra layer or a portion of radio-opaque material. Nevertheless, the refractory-metals and refractory-metal alloys may not be overly “bright” and therefore do not obscure the image of the surrounding tissue, as would be the case with a device made from an extremely dense material. In addition, the refractory-metals and refractory-metal alloys can be made to be MRI safe and compatible, and visible under MRI.

### SUMMARY

Embodiments of methods for fabricating refractory-metal articles (e.g., stents), and embodiments of honing and blasting apparatuses for use in such methods are disclosed. Refractory metals may have favorable mechanical properties, x-ray and MRI properties, and excellent biocompatibility. Methods for fabricating refractory-metal articles include laser cutting in a vacuum environment and/or at least one mechanical or chemical finishing step configured to remove at least one region affected by the fabrication process (e.g., the laser cutting process) to provide an improved surface finish.

In one embodiment, a method of laser cutting is disclosed. The method can include disposing a first refractory-metal article in a chamber of a laser cutting apparatus and drawing a partial vacuum in the chamber having the first refractory-metal article disposed therein. The method further includes laser cutting the refractory-metal article with the partial vacuum drawn to form a second refractory-metal article.

In one embodiment, a method for finishing a refractory-metal can include providing a first refractory-metal article including one or more regions affected by at least one manufacturing process. The one or more regions include at least one of a heat-affected zone, dross, a slag, an oxide-rich zone, an island, a burr, or a score mark. The method further includes finishing the first refractory-metal article to remove the one or more regions therefrom affected by at least one manufacturing process to form a finished second refractory-metal article, such as an implantable device.

In one embodiment, the finishing includes mechanically finishing the second refractory-metal article. Suitable examples of mechanical finishing processes can include, but are not limited to, honing and blasting with abrasive particles. In another embodiment, the finishing includes chemically finishing the first refractory-metal article. Suitable examples of chemical finishing processes can include, but are not limited to, etching in an acid bath, and electropolishing.

In one embodiment, a method for manufacturing an implantable medical device is disclosed. The method can include (1) providing a first refractory-metal article, the first refractory-metal article including a material selected from the group consisting of tantalum, niobium, tungsten, and alloys thereof, (2) disposing the first refractory-metal article in a chamber of a laser cutting apparatus, (3) drawing a partial vacuum in the chamber having the refractory first refractory-metal article disposed therein to a vacuum level of about 25 torr to about 10⁻¹² torr in pressure such that hydrogen embrittlement does not occur in the first refractory-metal article during and/or after the laser cutting, (4) laser cutting the first refractory-metal article under the partial vacuum to form a second refractory-metal article. The method can further include (5) mechanically and/or chemically finishing the second refractory-metal article to remove one or more regions therefrom affected by at least one manufacturing process including laser cutting using at least one of honing, blasting, thermal blasting, chemically etching using an acid, or electropolishing, and (6) annealing the mechanically and/or chemically finished second refractory-metal article to yield the implantable medical device.

Suitable examples of implantable devices that can be manufactured according to the methods described above include, but are not limited to, implantable refractory-metal stents, PFO closure devices, and the like.

In one embodiment, a honing apparatus configured for honing a tantalum-based refractory metal implantable article in order to remove one or more regions therefrom affected by at least one manufacturing process is disclosed. According to the present disclosure, the honing apparatus can include an abrasive file that is dimensioned to be inserted into an interior passageway of the implantable article, a motor structure configured for gripping and rotating the abrasive file, an arrester configured for holding the file in a substantially straight orientation, and a roller positioned and configured to bias interior surfaces defining the interior passageway of the implantable article against the file.

In one embodiment, a blasting apparatus configured for blasting an implantable article in order to remove one or more regions therefrom affected by at least one manufacturing process is disclosed. According to the present disclosure, the blasting apparatus can include a support structure, at least one blasting nozzle mounted to the support structure, the blasting nozzle being configured to direct high-velocity abrasive particles from a source of said particles toward an implantable article, a roller assembly disposed on the support structure, the roller assembly being configured to cradle, position, and rotate the implantable article under the at least one blasting nozzle, and a plurality of biasing elements operatively coupled to the support structure and the roller assembly, the biasing elements being configured to provide a selective amount of compressive pressure to the implantable article disposed in between the rollers.

In one embodiment, the blasting apparatus can further include a motor structure operatively coupled to at least one of the rollers such that the motor structure can rotate the implantable article disposed in the rollers. Rotating the implantable article under the nozzle can, for example, allow the high-velocity blasting particles to access all sides of the implantable article.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only illustrated embodiments of the present disclosure and are therefore not to be considered limiting of its scope. The present disclosure will be described and explained with additional specificity and detail through the use of the accompanying drawings in which:

FIG. 1 is a flow diagram of a method for laser cutting a refractory-metal article according to one embodiment of the present disclosure;

FIG. 2 is a flow diagram of a method for finishing a laser cut refractory-metal article according to one embodiment of the present disclosure;

FIG. 3 is a flow diagram of a more detailed method for laser cutting and finishing refractory-metal article according to one embodiment of the present disclosure;

FIG. 4A is an isometric view of a honing apparatus configured to hone an inner surface of a laser-cut stent according to one embodiment of the present disclosure;

FIG. 4B is an enlarged isometric view of the honing apparatus shown in FIG. 4A with a stent disposed on the honing file;

FIG. 5A is an isometric view of a blasting apparatus configured to blast a laser-cut article with abrasive particles according to one embodiment of the present disclosure;

FIG. 5B is an isometric view of the apparatus shown in FIG. 5A with the blasting nozzles removed for clarity;

FIG. 6A is an oblique view of the blasting apparatus shown in FIG. 5A with a stent disposed between the rollers;

FIG. 6B is a cut-away end view of the blasting apparatus shown in FIG. 6A showing the relative arrangement of the rollers and a stent disposed therebetween according to one embodiment of the present disclosure;

FIG. 7A is a side elevation view of an apparatus configured for annealing refractory-metal articles having a retractable heating element shown in a withdrawn position according to one embodiment of the present disclosure;

FIG. 7B is a side elevation view of the apparatus illustrated in FIG. 7A with the retractable heating element shown in a drawn in position; and

FIG. 8 is a cross-sectional view of an interlock assembly shown in FIG. 7B taken along line 8-8.

### DETAILED DESCRIPTION

### I. Introduction

Embodiments of methods for fabricating refractory-metal articles and embodiments of honing and blasting apparatuses for use in such methods are disclosed. In particular, refractory-metal articles that can be fabricated according to the methods disclosed herein include implantable medical devices such as refractory-metal stents. Methods for fabricating refractory-metal articles may include laser cutting in a vacuum environment and/or at least one of a mechanical or a chemical finishing step that removes at least one region affected by the fabrication process (e.g., the laser cutting process) to provide an improved surface finish. Providing an improved surface finish can, for example, improve patient outcomes by speeding healing and recovery of the patient. An improved surface finish can also improve the fatigue life of an implantable medical device.

### II. Methods of Manufacturing a Refractory-Metal Article

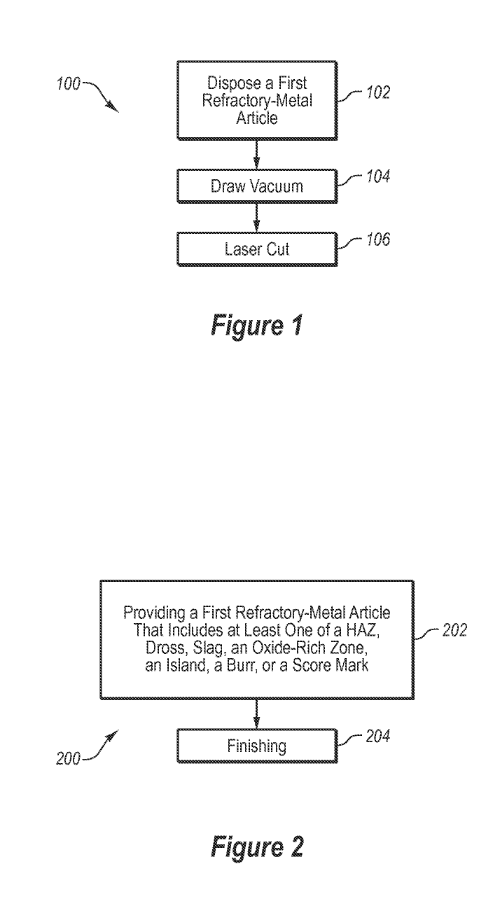

Referring now to FIG. 1, a flow diagram of a method 100 for laser cutting a refractory-metal article according to one embodiment of the present disclosure is illustrated. The method 100 for laser cutting the refractory-metal article can include (1) an act 102 of disposing a first refractory-metal article in a chamber of a laser cutting apparatus, (2) an act 104 of drawing a partial vacuum in the chamber having the first refractory-metal article disposed therein, and (3) an act 106 of laser cutting the refractory-metal article with the partial vacuum drawn to form a second refractory-metal article.

Metals such as tungsten, molybdenum, tantalum, niobium, rhenium, and alloys thereof are known to be highly reactive with and/or have a high solubility for oxygen, hydrogen, and other atmospheric gases and gaseous impurities commonly found in purging gases (e.g., small percentages of oxygen and hydrogen contaminants are commonly found in commercially pure argon). It is therefore desirable to limit the presence of gases during the laser cutting process. As such, in one embodiment, the act 104 of drawing the partial vacuum may provide a sufficient vacuum level so that the first refractory metal article does not react with and/or dissolve a sufficient amount of hydrogen to cause hydrogen embrittlement during and/or after the act of laser cutting. For example, the partial vacuum can be characterized as a vacuum environment ranging from about 25 torr to about 10⁻¹² torr in pressure (i.e., approximately 3000 Pa to approximately 10⁻¹⁰ Pa). The pressure may range from about 1 torr to about 10⁻⁷ torr (i.e., approximately 100 Pa to approximately 10⁻⁵ Pa) or, more specifically, the pressure may range from about from about 10⁻³ torr to about 10⁻⁷ torr (i.e., approximately 10⁻¹ Pa to approximately 10⁻⁵ Pa).

In one embodiment, the first refractory-metal article may be configured as a billet, a tube, or the like. Suitable examples of the second refractory-metal article include medical implants and devices including minimal-invasive devices, such as, guide wires, catheters (balloon catheters, guiding catheter, angiographic catheters, functional catheters, . . . ), intra-cavernous implants, in particular intra-esophagus, intra-urethra, intra-tracheal implants and intra-vascular implants, in particular stents, stent grafts, stent graft connector, heart valve repair device, or filters.

Suitable examples of lasers that can be used to cut the first refractory-metal article include, but are not limited to, fiber lasers and ultrashort pulse lasers such as a picosecond lasers. A fiber laser is a laser in which the active gain medium is an optical fiber doped with rare-earth elements such as erbium, ytterbium, neodymium, dysprosium, praseodymium, and thulium. Typical fiber lasers cut by melting through the material, which can produce a significant heat-affected zone and metallic slag. Fiber lasers are typically pumped by semiconductor laser diodes or by other fiber lasers.

A picosecond (ps) laser is a laser that emits high-energy pulses of optical radiation that can cut materials, such as refractory-metals, by ablation (i.e., vaporization) of the material. A typical ps-laser pulse has a duration between about 1 ps and some tens of picoseconds. Ps-pulses are short enough to avoid thermal diffusion of the energy and reach the peak power densities necessary for these ablation processes. As a result, ps-lasers typically do not substantially produce slag or produce a minimal amount of slag associated with the cut, and the size of the heat-affected zone is minimized. A variety of laser types can generate picosecond pulses, with other performance parameters varying in wide ranges. Suitable lasers include actively or passively mode-locked solid-state bulk lasers. These can provide very clean (i.e., transform-limited and low-noise) ultrashort pulses with pulse repetition rates varying from a few megahertz to more than 100 GHz. For example, a passively mode-locked Nd:YAG or vanadate laser can easily generate 10-ps pulses with several watts of output power, and thin-disk lasers can generate many tens of watts in shorter pulses.

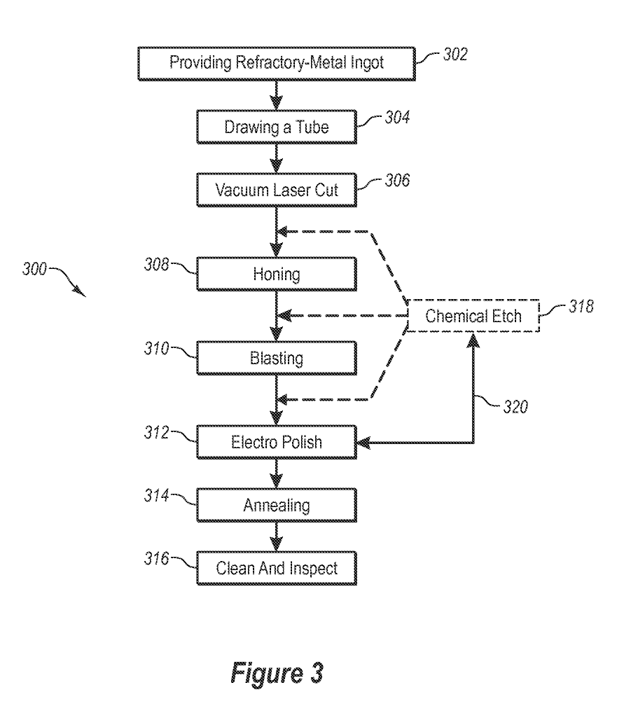

Referring now to FIG. 2, embodiments disclosed herein also include methods of finishing a laser-cut refractory-metal article that may or may not have been laser cut in a partial vacuum environment as performed in the method 100 shown in FIG. 1. FIG. 2 is a flow diagram of a method 200 for finishing a laser cut refractory-metal article according to one embodiment of the present disclosure. The method 200 can include an act 202 of providing a first refractory-metal article that includes one or more regions affected by at least one manufacturing process. The one or more regions include at least one of a heat-affected zone, dross, a slag, an oxide-rich zone, an island, a burr, or a score mark. For example, the heat-affected zone, dross, and/or slag may be formed in the first refractory-metal article by laser cutting a workpiece in an environment that does not sufficiently shield the workpiece from oxygen, hydrogen, and/or other gases. The method 200 further includes an act 204 of finishing the first refractory-metal article to remove the one or more regions therefrom affected by the at least one manufacturing process to form a finished second refractory-metal article.

In one embodiment, the act 202 can include providing a first refractory-metal article manufactured using at least one of drawing (e.g., drawing a billet of metal to form a tube or another structure), laser cutting, or vacuum laser cutting.

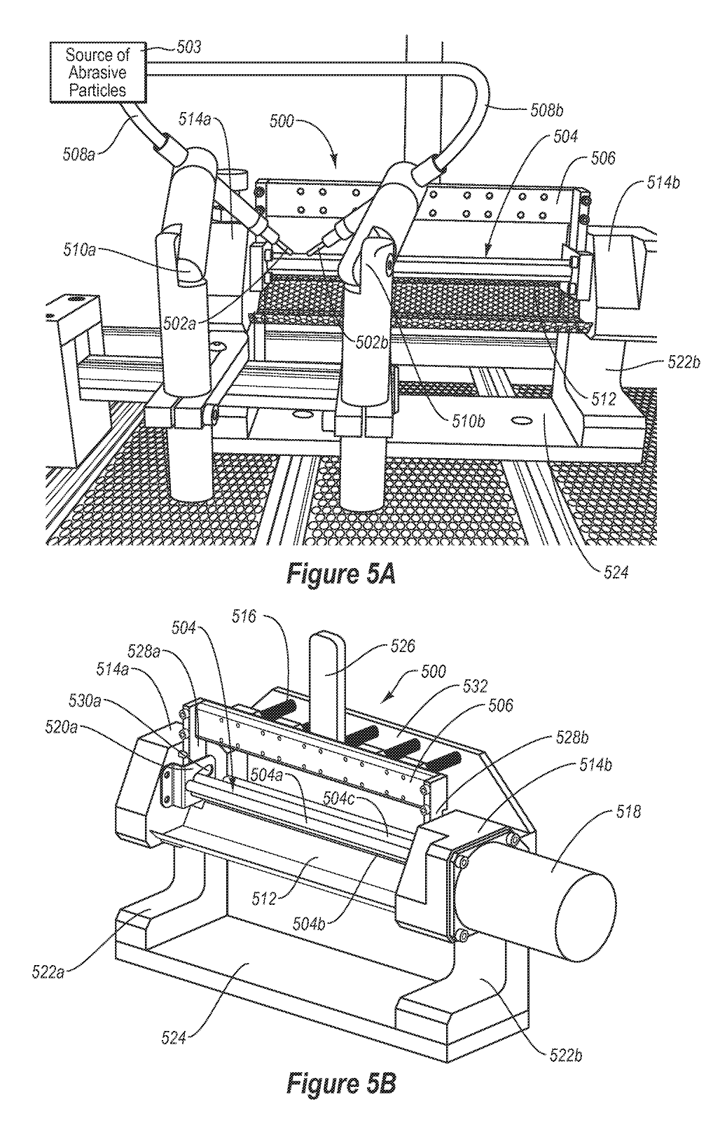

In one embodiment, the act 204 can include mechanically finishing the first refractory-metal article to form the finished second refractory-metal article. Suitable examples of mechanical finishing processes can include, but are not limited to, honing, blasting with abrasive particles, and combinations of the foregoing processes. As an alternative to or in addition to honing and/or blasting, thermal blasting using high-velocity, super-heated gas may also be used. Embodiments of honing and abrasive blasting apparatuses and processes will be discussed below in more detail with reference to FIGS. 4A-6B. In an embodiment, the first refractory-metal article may be blasted after being honed to remove burrs produced during the honing process.

In another embodiment, the first refractory-metal article may be formed by laser cutting and the laser-cut refractory-metal article may be finished using a chemical finishing process to form the finished second refractory-metal article. Suitable examples of chemical finishing processes can include, but are not limited to, etching in an acid bath (e.g., including HF) and electropolishing.

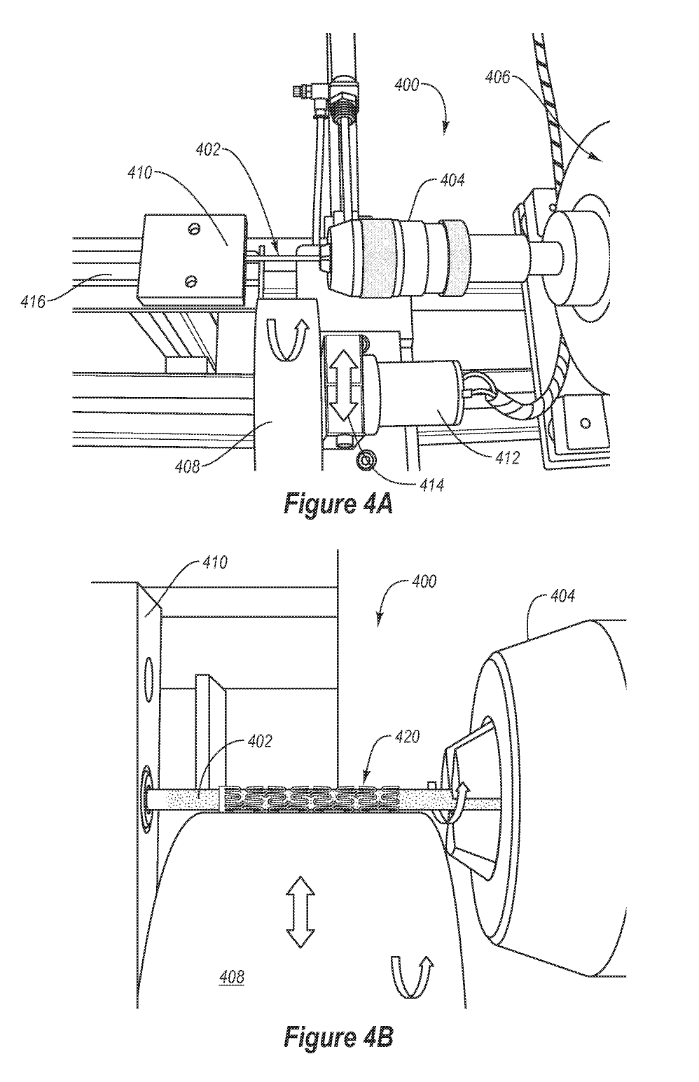

Referring now to FIG. 3, a flow diagram of a more detailed method 300 for laser cutting and finishing refractory-metal article according to one embodiment of the present disclosure is illustrated. The method 300 can include (1) an act 302 of providing a refractory-metal ingot including a material selected from the group consisting of tantalum, niobium, tungsten, and alloys thereof, and (2) an act 304 of forming a first refractory-metal article (e.g., a drawn tube) from the refractory-metal ingot. The method can further include (3) an act 306 of disposing the first refractory-metal article in a chamber of a laser cutting apparatus and laser cutting under a partial vacuum to form a second refractory-metal article, and (4) an act 308 of honing the second refractory-metal article to remove one or more regions from the second refractory-metal article affected by the laser cutting (e.g., a slag or an island) or an upstream manufacturing process (e.g., a score mark from the drawing process used to form the first refractory-metal article). The method can further include (5) an act 310 of blasting the second refractory-metal article to remove additional defects (e.g., burrs raised by the honing in act 308) from the surface of the second refractory-metal article, (6) an act 318 of chemically etching in an acid bath can optionally be performed after at least one of the act 306 of laser cutting, the act 308 of honing, or the act 310 of blasting, (7) an act 312 of electropolishing the honed, blasted, and/or chemically etched second refractory-metal article, and (8) the act 318 of chemically etching and the act 312 of electropolishing can optionally be performed multiple times in turn until the desired surface finish is achieved, preferably finishing with an act 312 of electropolishing. The method can further include (9) an act 314 of annealing in an annealing oven, and (10) an act 316 of cleaning and inspecting the finished article.

In one embodiment, the refractory-metal ingot provided in the act 302 can be fabricated using a technique that may at least substantially homogenize the microstructure of the metal ingot. For example, the microstructure of the metal ingot can be substantially homogenized using an equal channel angular extrusion technique. In an example of an equal channel angular extrusion technique, a bar of metal (e.g., a cylindrical bar of refractory metal) with an as-cast, inhomogeneous microstructure is forced through an angled die having a defined angle between an inlet channel and an outlet channel. For example, the angle between the inlet channel and the outlet channel may be 100°, 90°, 60°, 30°, any angle therebetween, or any other angle selected by a person having skill in the relevant art. In one embodiment, the inlet and outlet channels of the die may have a diameter that is essentially equal to the diameter of the metal bar so that the metal bar does not change in cross-sectional are in the extrusion process.

When the bar is forced through the angled channel, the bar undergoes a severe plastic deformation (e.g., a shear deformation) without a change in cross-sectional area. The severe plastic deformation mixes and serves to homogenize the microstructure of the metal. The angle between the inlet channel and the outlet channel may be varied to achieve different shear rates and different rates of homogenization. The bar may be passed through the die multiple times (e.g., up to eight times) to achieve uniform deformation and uniform homogenization. This deformation process may homogenize and refine the microstructure of the refractory metal ingot to improve the strength and mechanical performance of the metal.

The refractory-metal articles employed in any of the methods discussed herein can be made from a refractory metal. Suitable examples of refractory metals include, but are not limited to, tantalum, niobium, tungsten, and alloys thereof. It has been found that a tantalum alloy that includes tantalum, niobium, and at least one additional element selected from the group consisting of tungsten, zirconium, molybdenum, and/or at least one of hafnium, rhenium, and cerium can fulfill the mechanical and biocompatibility requirements needed for functioning as in a medical device.

In one embodiment, the refractory metal articles disclosed herein can be made from an alloy including (a) about 0.1 weight percent to about 70 weight percent niobium, (b) about 0.1 weight percent to about 30 weight percent of at least one element selected from the group consisting of tungsten, zirconium, and molybdenum, (c) up to 5 weight percent of at least one element selected from the group consisting of hafnium, rhenium, and cerium, (d) and tantalum.

In another embodiment, the refractory metal articles disclosed herein can be made from a tantalum alloy that includes a tantalum content of about 78 weight-percent (“wt %”) to about 91 wt %, a niobium content of about 7 wt % to about 12 wt %, and a tungsten content of about 1 wt % to about 10 wt %. However, the tantalum alloy may also include other alloying elements, such as one or more grain-refining elements in an amount up to about 5 wt % of the tantalum alloy. For example, the one or more grain-refining elements may include at least one of hafnium, cerium, or rhenium. Tungsten is provided to solid-solution strengthen tantalum, and niobium is provided to improve the ability of tantalum to be drawn. The tantalum alloy is a substantially single-phase, solid-solution alloy having a body-centered cubic crystal structure. However, some secondary phases may be present in small amounts (e.g., inclusions) depending upon the processing employed to fabricate the tantalum alloy.

The composition of the tantalum alloy may be selected from a number of alloy compositions according to various embodiments. In an embodiment, the niobium content is about 9 wt % to about 10.5 wt %, the tungsten content is about 6.0 wt % to about 8 wt %, and the balance may include tantalum (e.g., the tantalum content being about 80 wt % to about 83 wt %) and, if present, other minor alloying elements and/or impurities. In a more detailed embodiment, the niobium content is about 10 wt %, the tungsten content is about 7.5 wt %, and the balance may include tantalum (e.g., the tantalum content being about 82.5 wt %) and, if present, other minor alloying elements and/or impurities. In another more detailed embodiment, the niobium content is about 10 wt %, the tungsten content is about 2.5 wt %, and the balance may include tantalum (e.g., the tantalum content being about 87.5 wt %) and, if present, other minor alloying elements and/or impurities.

In another embodiment, the niobium content is about 10.5 wt % to about 13 wt %, the tungsten content is about 5.0 wt % to about 6 wt %, and the balance may include tantalum (e.g., the tantalum content being about 80 wt % to about 82 wt %) and, if present, other minor alloying elements and/or impurities. In a more detailed embodiment, the niobium content is about 12.5 wt %, the tungsten content is about 5.8 wt %, and the balance may include tantalum (e.g., the tantalum content being about 81 wt % to about 81.5 wt %) and, if present, other minor alloying elements and/or impurities.

In a specific example, the tantalum-containing refractory metal article disclosed herein may be made from a tantalum alloy that includes about 82.5 weight percent tantalum, about 10 weight percent niobium, and about 7.5 weight percent tungsten.

In another specific example, the tantalum-containing refractory metal article disclosed herein may be made from a tantalum alloy that includes about 87.5 weight percent tantalum, about 10 weight percent niobium, and about 2.5 weight percent tungsten.

In an embodiment, the refractory metal (e.g., a tantalum alloy) may exhibit a grain microstructure including recrystallized, generally equiaxed grains characteristic of being formed by heat treating a precursor product or a stent body itself, both of which may be severely plastically deformed in a drawing process. Depending upon the extent of recrystallization process, the grain microstructure may be only partially recrystallized. In some embodiments, the recrystallization process may substantially completely recrystallize the grain microstructure with the new recrystallized grains having consumed substantially all of the old deformed grains. Even when the grain microstructure is partially recrystallized, it will be apparent from microstructural analysis using optical and/or electron microscopy that the grain microstructure includes some recrystallized grains having, for example, a generally equiaxed geometry. An average grain size of the tantalum alloy may be about 10 μm to about 20 μm and, more particularly, about 13 μm to about 16 μm depending on the extent of recyrstallization and the amount of the optional one or more grain-refining alloy elements in the tantalum alloy.

In other embodiments, the refractory metal alloy may be stress relieved at a temperature below a recrystallization temperature of the tantalum alloy so that the grain microstructure is relatively unchanged from the as-drawn condition. Thus, in the stress-relieved condition, the grain microstructure may include essentially only non-equiaxed, deformed, cold-worked grains. However, the stress-relief heat treatment may at least partially remove at least one of hydrogen, oxygen, or oxygen from the tantalum alloy, which can detrimentally embrittle the tantalum alloy. Thus, the tantalum alloy in the stress-relieved condition may exhibit an improved ductility relative to the as-drawn condition, while the tensile yield strength and tensile ultimate tensile strength are generally unaffected by the stress-relief heat treatment.

The heat-treated refractory metal alloy from which the articles disclosed herein may be made may exhibit combination of strength (e.g., tensile yield strength and ultimate tensile strength) and ductility (e.g., percent elongation) suitable to withstand loading conditions encountered when implanted and utilized in a lumen of a living subject. The tensile yield strength may be the 0.2% offset yield strength determined in a uniaxial tensile test when no yield point is present, and the yield point if the tantalum alloy exhibits a yield point. For example, the tantalum alloy may exhibit a tensile elongation of about 9% to about 40%, a tensile yield strength of about 400 MPa to about 815 MPa, and an ultimate tensile strength of about 500 MPa to about 850 MPa as determined by, for example, tensile testing a tubular body from which the stent body may be cut from or a drawn wire in a uniaxial tensile test. In an embodiment, the tantalum alloy (e.g., about 82.5 wt % tantalum, about 10 wt % niobium, and about 7.5 wt % tungsten) may exhibit a tensile elongation of about 9% to about 40%, a tensile yield strength of about 455 MPa to about 810 MPa, and an ultimate tensile strength of about 515 MPa to about 850 MPa. In another embodiment, the tantalum alloy may exhibit a tensile elongation of about 10% to about 25%, a tensile yield strength of about 400 MPa to about 500 MPa, and an ultimate tensile strength of about 500 MPa to about 550 MPa. In one embodiment, the tantalum alloy may exhibit a tensile elongation of about 20% to about 23%, a tensile yield strength of about 450 MPa to about 500 MPa, and an ultimate tensile strength of about 500 MPa to about 550 MPa.

In an embodiment, a heat-treated refractory metal from which the articles disclosed herein may be fabricated is made having a tantalum content of about 87.5 wt %, a niobium content of about 10 wt %, and a tungsten content of about 2.5 wt % and an at least partially recrystallized grain microstructure may exhibit a tensile elongation of about 9% to about 40%, a tensile yield strength of about 400 MPa to about 800 MPa, and an ultimate tensile strength of about 500 MPa to about 850 MPa. In one embodiment, the heat-treated tantalum alloy may exhibit a tensile elongation of about 10% to about 25%, a tensile yield strength of about 400 MPa to about 500 MPa, and an ultimate tensile strength of about 500 MPa to about 550 MPa.

In an embodiment, a stress-relieved refractory metal alloy from which the articles disclosed herein may be fabricated is made having a tantalum content of about 82.5 wt %, a niobium content of about 10 wt %, and a tungsten content of about 7.5 wt % may exhibit a percent elongation of about 9% to about 15% (e.g., about 10% to about 11%), a tensile yield strength of about 650 MPa to about 850 MPa, and an ultimate tensile strength of about 700 MPa to about 850 MPa. In the stress-relieved condition, the percent elongation of the tantalum alloy may increase by at least about 100%, at least about 200%, at least about 300%, or about 200% to about 300% compared to the same tantalum alloy in the as-drawn (i.e., un-stress-relieved condition), while the tensile yield strength and ultimate tensile strength are reduced. As yield strength and ultimate tensile strength go down, the ductility of the tantalum alloy tends to increase. The reduction in tensile yield strength and ultimate tensile strength and the increase in ductility needs to be balanced, but, in general, increasing ductility tends to yield a more durable medical device fabricated from the tantalum alloy. For example, an alloy having increased ductility is less likely to crack when radially stressed. The grain microstructure may also be relatively un-changed from the as-drawn condition and may include deformed, non-equiaxed grains.

In one embodiment, the chemical etching process employed in act 318 to chemically etch the laser cut article may include disposing the laser cut article in an etching solution that includes at least one mineral acid. A mineral acid is an inorganic acid derived from one or more inorganic compounds. All mineral acids release hydrogen ions when dissolved in water. Suitable examples of mineral acids include, but are not limited to, hydrochloric acid (HCl), nitric acid (HNO₃), phosphoric acid (H₃PO₄), sulfuric acid (H₂SO₄), hydrofluoric acid (HF), and hydrobromic acid (HBr).

Mineral acid etchants can be used to etch the surface of laser cut articles made from most metals. However, the refractory metal alloys discussed herein are particularly chemically resistant. In the case of a refractory metal alloy (e.g., a tantalum alloy) the chemical etchant may include HF and may include at least one other acid. For example, the chemical etching step employed in act 318 may include disposing the laser cut article (e.g., a refractory metal stent) in a chemical etching solution that includes HF, HNO₃, and, optionally, urea.

Electropolishing, as performed in act 312, is an electrochemical process that removes material from a metallic workpiece. Electropolishing is often referred to as a “reverse plating” process. Electrochemical in nature, electropolishing uses a combination of rectified current and a blended chemical electrolyte bath to remove flaws from the surface of a metal part.

Typically, the metal work piece is immersed in a temperature controlled bath of electrolyte and connected to the positive terminal (anode) of a DC power supply, the negative terminal being attached to an auxiliary electrode (cathode). A current passes from the anode to the cathode through the electrolyte solution. At the anode, metal on the surface of the workpiece is oxidized and dissolved in the electrolyte. At the cathode, a reduction reaction, normally hydrogen evolution, takes place. Electrolytes used for electropolishing are most often concentrated acid solutions.

Electropolishing of the metal work piece may be performed by immersing the metal work piece in a temperature-controlled bath of electrolyte, and connecting a positive terminal (anode) of a direct current (“DC”) power supply to the metal work piece and a negative terminal of the DC power supply to an auxiliary electrode (cathode). A current passes from the anode to the cathode through the electrolyte solution. At the anode, metal on the surface of the metal work piece is oxidized and dissolved in the electrolyte. At the cathode a reduction reaction takes place, which normally evolves hydrogen. Electrolytes used for electropolishing are most often concentrated acid solutions. To achieve electropolishing of a rough metal surface, the protruding parts of a surface profile must dissolve faster than the recesses. This behavior (referred to as anodic leveling) is achieved by applying a specific electrochemical condition (e.g., voltage, current, and/or acid concentration/acid makeup). While electropolishing processes are best known for the bright polish left on the surface of polished workpieces, there are some important, often overlooked benefits of this metal finishing technique. These benefits include, but are not limited to, deburring, size control, and microfinish improvement.

In one embodiment, the electrolyte solution employed in the electropolishing step 312 is an inaqueous acidic solution. For example, the electrolyte solution may contain methanol (or another alcohol), sulfuric acid (H₂SO₄), methanolic hydrochloric acid (methanol-HCl) and, optionally, a desiccating agent such as polyethylene glycol (PEG) or ethylene glycol. In a specific example, the H₂SO₄ concentration in the electrolyte solution is about 2 molar (M) to about 3 M and the HCl concentration is about 0.5 M to about 1 M, and the desiccating agent concentration is about 0.004 M to about 0.010 M.

Laser cut articles may be electropolished in the electrolyte solution (i.e., methanol, H₂SO₄, and methanol-HCl) using a threshold current of at least about 4 amps. The electrical current directed through the electrolyte solution needs to be above the threshold current in order to achieve a smoothing or polishing effect on the surface of the laser cut articles as opposed to a roughening or etching effect. As the electropolishing process proceeds, H₂SO₄ is consumed producing H₂ gas and metal sulfates. Eventually, as the H₂SO₄ is consumed, the current will drop below the threshold value. When the current drops below the threshold value, the solution needs to be discarded. 800 ml of electrolyte solution is, for example, sufficient for electropolishing about 80 laser cut refractory metal stents (e.g., tantalum alloy stents).

While the electrolyte solution is essentially water-free as it is prepared, the solution is hygroscopic and will scavenge water out of the environment. In the case of the refractory metal alloys discussed herein, the electrolyte solution is formulated to be essentially water-free because water will react with the surface of the refractory metal and form an oxide passivation layer on the surface of the metal that can interfere with the electropolishing process. PEG 1000 (i.e., PEG having an average molecular weight of about 1000 daltons) can be added at a concentration of about 0.004 M (i.e., about 4 milimolar). PEG, ethylene glycol, and similar desiccating agents are capable of forming multiple hydrogen bonding interactions and can surround and effectively sequestering water that may otherwise interfere with the electropolishing process.

The tantalum alloys disclosed herein may have a passive oxide film primarily composed of tantalum-oxide (Ta₂O₅). Such a passive oxide film may be generally more durable and more corrosion resistant than, for example, a chromium-oxide film formed during passivation of stainless steel. The tantalum alloys disclosed herein may exhibit a substantially single phase body-centered cubic crystal structure, which is uniform and corrosion resistant, and has the ability for conversion oxidation or nitridization surface hardening of a medical implant or device made therefrom.

To further improve the biocompatibility of a medical implant or device fabricated at least in part from the tantalum alloy disclosed herein, at least a portion of the surface of the laser cut or finished refractory-metal articles can be conversion surface hardened and/or coated. Such coatings can include, but are not limited to a polymer, a blend of polymers, a metal, a blend of metals, a ceramic and/or biomolecules, in particular peptides, proteins, lipids, carbohydrates and/or nucleic acids (e.g. collagen, heparin, fibrin, phosphorylcholine, cellulose, morphogenic proteins or peptides, growth factors). Furthermore the alloy surface or the coatings can comprise stem cells and/or a bioactive substance, in particular drugs, antibiotics, growth factors, anti-inflammatory agents and/or anti-thrombogenic agents.

### II. Honing, Blasting, and Furnace Apparatuses for Use in the Methods Disclosed Herein

Referring now to FIGS. 4A and 4B, an embodiment of a honing apparatus 400 that can be used to hone an inner surface of a laser-cut stent 420 is illustrated.

After laser cutting, an implantable article (e.g., a stent) can include a number of regions affected by the laser cutting including slag, dross, islands (i.e., sections of metal that are cut away from the stent but that are still attached by slag), and/or heat-affected zones that may be evidenced by visible discoloration. The implantable article can also include regions affected by one or more up-stream manufacturing processes (e.g., score marks from drawing). The refractory-metals discussed herein are highly chemically resistant and, as such, it can be difficult (but not impossible) to remove surface defects such as slag and/or score marks by chemical methods (i.e., etching and electropolishing) alone.

The honing apparatus 400 is configured to hone and/or ream out an inner surface of a stent or another implantable article in order to remove the slag, dross, island regions, and/or heat-affected zones thereof. The honing apparatus 400 includes a file 402 (e.g., a diamond-coated steel file, a ceramic file, or other abrasive tool) that is dimensioned to be inserted into an interior passageway (not labeled) of a stent 420 (FIG. 4B), a chuck 404 that grips the file 402, and a first motor or another drive structure 406 that is coupled to the chuck 404 and configured to rotate the chuck 404 and the file 402 attached thereto. The honing apparatus 400 further includes, an arrester 410 that is configured to hold the file 402 in a substantially straight orientation while the file 402 is spinning, and a sliding track 416 that allows the arrester 410 to be moved back and forth. The honing apparatus 400 also includes a roller 408 that is positioned and configured to bias interior surfaces defining the interior passageway of the stent 420 against the file 402 while the file 402 is rotated. The honing apparatus also includes a second motor or another drive structure 412 that is coupled to the roller 408 and configured to rotate the roller and a sliding track 414 that includes a fine pitch thread (not shown) that allows the distance between the file 402 and the roller 408 to be adjusted in order to control the amount of material removed from the stent 420 in the honing process.

In practice, a laser-cut stent (e.g., stent 420) can be honed with the honing apparatus 400 by withdrawing arrester 410 and inserting the file 402 into the interior passageway of the stent 420. The roller 408 can then be adjusted to hold the stent 420 against the file 402. Once adjusted, the roller 408 and the file 402 are rotated simultaneously in order to hone the stent 420. The file 402 may be rotated at, for example, about 5000-10,000 rpm and the roller 408 may be rotated at, for example, about 1-10 rpm. The roller 408 can be rotated either in the same direction as the file 402 or in the opposite direction. The stent 420 can be honed using the honing apparatus 400 in about 10-60 seconds.

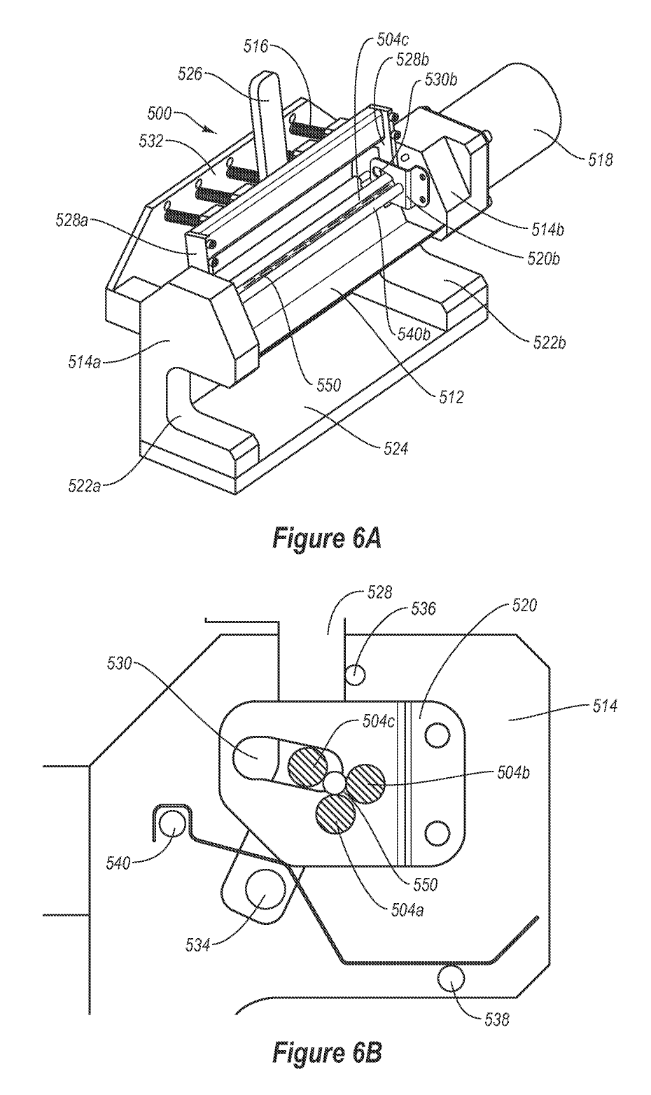

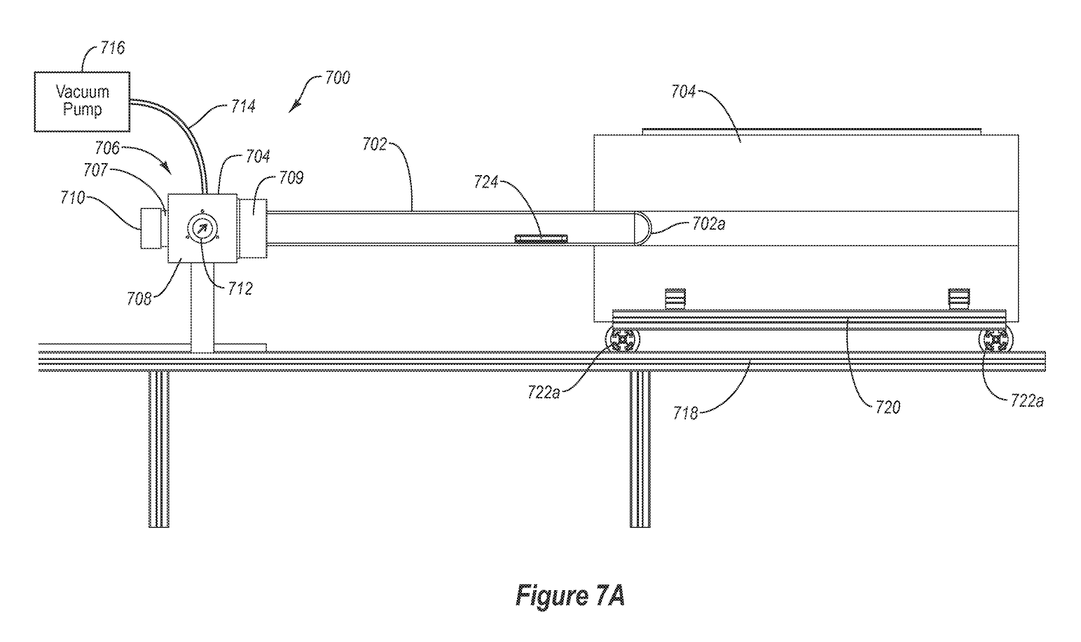

Referring now to FIGS. 5A-6B, an embodiment of a blasting apparatus 500 is illustrated that is configured to mechanically finish a stent. For example, the blasting apparatus 500 can be used to perform the act 204 in the method 200 shown in FIG. 2. While the discussion herein focuses on refractory metal stents (e.g., stents made from a tantalum alloy), one will appreciate that the blasting apparatus 500 can be used to blast stents and other roughly cylindrical objects made from essentially any material. In addition, the blasting apparatus 500 is advantageously capable of simultaneously blasting the inner diameter surface and the outer diameter surface of a stent.

The blasting apparatus 500 is configured for blasting a laser-cut stent or another substantially cylindrical article with abrasive particles, such as silica particles, alumina particles, or other suitable abrasive particles. The blasting apparatus 500 includes a first frame section 514a spaced from a second frame section 514b. A pair of legs 522a and 522b extend from corresponding first and second frame section 514a and 514b. Each leg 522a and 522b is connected to a base 524 that serves as a support structure.

As illustrated in FIG. 5A, the blasting apparatus 500 includes a plurality of blasting nozzles 502a and 502b. The blasting nozzles 502a and 502b are each mounted on articulated supports 510a and 510b that permit the aiming of the blasting nozzles 502a and 502b. Abrasive media is fed to blasting nozzles 502a and 502b from a source of abrasive particles 503 via hoses 508a and 508b.

A roller assembly 504 is positioned between the first and second frame sections 514a and 514b and configured to cradle, position, and rotate a stent under the blasting nozzles 502a and 502b. In one embodiment, a tray 512 may be provided under the roller assembly 504. The tray 512 may be configured, for example, to catch stents or other blasted articles when the roller assembly is opened after blasting. Referring now to FIG. 5B, the roller assembly 504 includes three rollers 504a-504c. One will of course appreciate that other roller assemblies can include either fewer or more rollers.

The rollers 504a-504c are fitted into a pair of brackets 520a and 520b that are mounted to corresponding first and second frame sections 514a and 514b. The roller 504c extends between and is mounted to support sections 528a and 528b, and can be selectively moved within slots 530a and 530b formed in corresponding brackets 520a and 520b by grasping and pulling a handle 526 that moves the support sections 528a and 528b having the roller 504c mounted thereto. The handle 526 is coupled to a backing piece 506 that is connected to the support sections 528a and 528b. A plurality of compression springs 516 or other biasing elements extend between the back plate 532 and the backing piece 506 to bias the roller 504c toward the other rollers 504a and 504b to provide a selective amount of compression to a stent disposed between the rollers 504a-504c. For example, the compression springs 516 may be connected to the back plate 532 and/or the backing piece 506.

Referring now to FIGS. 6A and 6B, the blasting apparatus 500 is shown with an example stent 550 disposed between the rollers 504a-504c of the roller assembly 504. In one example, the stent 550 can be loaded into the blasting apparatus 500 by grasping and pulling back on the handle 526 to retract the roller 504c within slots 530a and 530b and away from the other rollers 504a and 504b. Retracting the roller 504c allows a user to place the stent 550 in a V-shaped depression formed between the rollers 504a and 504b. With the stent 550 in place, the handle 526 can be released allowing roller 504c to press against the stent 550 with the compression springs 516 providing the appropriate amount of compression against the stent 550. For example, the when the roller 504c is biased in position against the stent 550, the rollers 504a-504c may form a stent receiving volume having a cross-sectional dimension of about 1 mm to about 10 mm, about 1 mm to about 8 mm, about 1 mm to about 6 mm, or about 1 mm to about 4 mm. By virtue of the stent receiving volume, the blaston apparatus 500 can blast stents (e.g., stent 550 in FIG. 6A) having a cross-sectional dimension of about 1 mm to about 10 mm, about 1 mm to about 8 mm, about 1 mm to about 6 mm, or about 1 mm to about 4 mm. One will appreciate, of course, that stents can be blasted in either an expanded state, a compressed state, or a partially compressed state. Depending upon the number of stents positioned in the stent receiving volume and the compressive force applied thereto by the roller 504c, the stents may be crimped due to the compressive force.

Referring to only FIG. 6B, a motor 518 (e.g., a small electric motor) may be coupled to at least a portion of the rollers 504a-504c of the roller assembly 504. For example, the motor 518 may be configured to rotate at least one of the rollers 504a-504c about a longitudinal axis thereof so that the stent 550 disposed in the roller assembly 504 is controllably rotated about a longitudinal axis thereof. Rotating the stent 550 allows the abrasive media to access the inside and outside surface of the stent 550 to more uniformly mechanically finish the stent 550. In photomicrographs of stents taken prior to blasting, burrs raised by honing and score marks produced by drawing were clearly apparent. In photomicrographs of stents taken after blasting with the blasting apparatus described herein, burrs or score marks on either the inner or outer surface of the stent were substantially reduced. In addition, the blasting is effective for removing an oxide surface layer that can form during stent processing. After blasting, the surface of the blasted stent can be finished by electropolishing to produce a substantially defect-free surface finish.

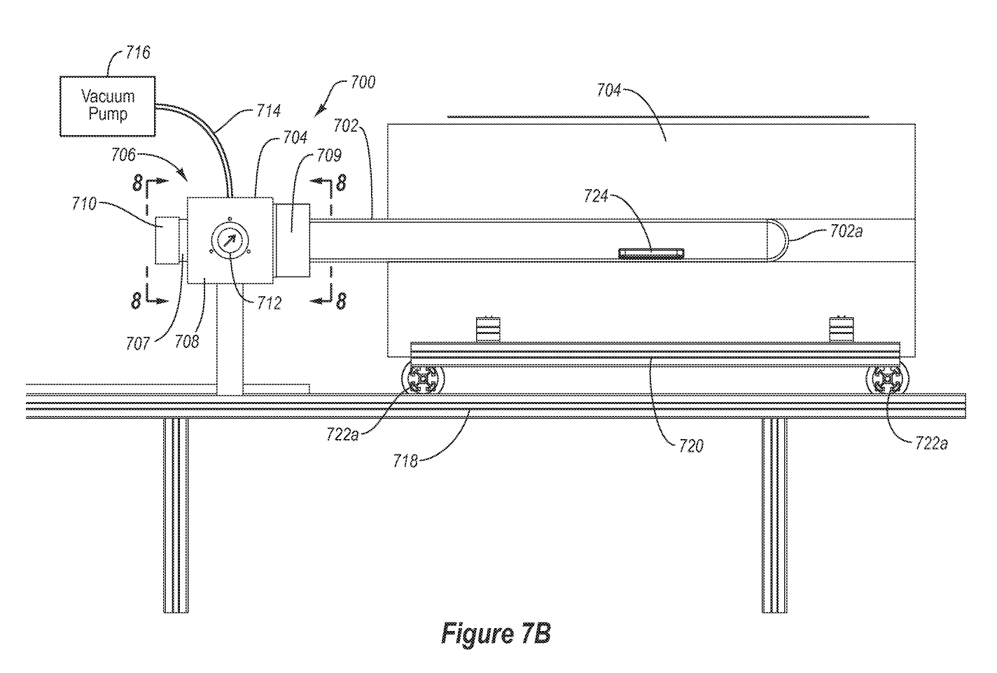

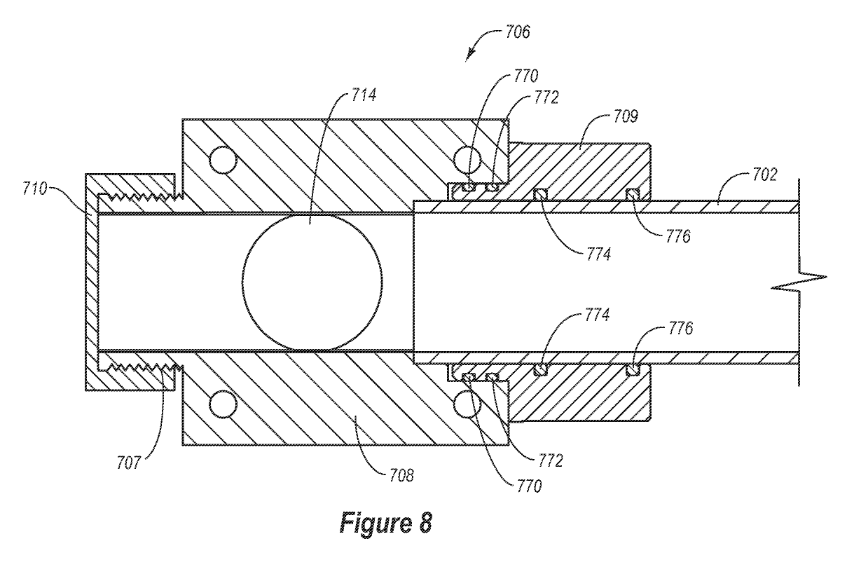

Referring now to FIGS. 7A-8, an embodiment of a furnace apparatus 700 for annealing a refractory-metal article in a vacuum environment is shown, which can be used to perform the act 314 of annealing in the method 300 shown in FIG. 3. The furnace apparatus 700 includes a support 718 (e.g., a table), a furnace tube 702 supported by the support 718, and a retractable heating element 704 that can be positioned around the furnace tube 702.

The furnace tube 702 includes a closed end 702a and an open end 702b. An interlock assembly 706 may be mounted to the furnace tube 702 at/or proximate to the open end 702b thereof. The interlock assembly 706 is configured to be opened in order to allow at least one refractory-metal article to be disposed in the furnace tube 702. The interlock assembly 706 includes an interlock body 708, and a furnace tube flange 709 that couples the interlock body 708 to the furnace tube 702. A cap 710 can be removably attached to the interlock body 708 to provide an air-tight seal to the furnace tube 702 and allow convenient access to the inside of the furnace tube 702.

As shown in FIGS. 7A and 7B, the interlock body 708 is coupled to a vacuum line 714 that is in turn coupled to a vacuum pump 716 that allows a vacuum to be drawn inside the furnace tube 702. The interlock body 708 additionally includes vacuum sensor 712 (e.g., a vacuum gauge) operably coupled to the interlock body 708 that allows a user to monitor the vacuum level in the furnace tube 702. Drawing a vacuum in the furnace tube 702 allows the annealing process to be conducted in an environment that is substantially free of oxygen, hydrogen and other gases that can dissolve and/or react with the refractory-metal articles disclosed herein.

Referring now to the heating element 704 of apparatus 700, the heating element 704 shown in FIGS. 7A and 7B is substantially cylindrical. However, other non-cylindrical configurations may be employed. The heating element 704 can surround a portion of the furnace tube 702 and apply even heating thereto. The heating element 704 is supported on a base 720 that can be moved on wheels 722 or other suitable structure to allow the heating element 704 to be moved back and forth on the support 718. FIG. 7A shows the apparatus 700 with the heating element 704 withdrawn from the furnace tube 702 and FIG. 7B shows the apparatus 700 with the heating element 704 positioned around the furnace tube 702. Positioning the heating element 704 around the furnace tube 702 and allowing it to be retracted allows the contents of the furnace tube 702 (e.g., a refractory-metal article on a tray 724) to be rapidly heated and cooled. Rapid heating and cooling during the annealing process can, for example, improve the overall material properties of an annealed refractory-metal article by reducing the amount of grain growth therein that can occur when slowly heated and/or cooled.

In a typical annealing process using the apparatus 700, the cap 710 is removed, at least one refractory-metal article (e.g., a refractory-metal stent) is placed in tray 724, the tray 724 is positioned in the furnace tube 720, and the furnace tube 702 is recapped by screwing the cap 710 back onto the interlock body 708. Once the furnace tube 702 is sealed, a vacuum can be drawn to a sufficient level (e.g., about 10⁻³ torr to about 10⁻⁷ torr) and the heating element 704 can be moved over the furnace tube 702. The heating element 704 is typically pre-heated to a temperature of about 1100° C. to about 1300° C. prior to moving over the furnace tube 702. Pre-heating the heating element 704 allows the furnace tube 702 and the refractory-metal article disposed therein to rapidly heat up to a selected annealing temperature (e.g., about 1100° C. to about 1300° C.).

Referring now to FIG. 8, additional details of the interlock assembly 706 are shown. The interlock assembly 706 is configured to provide an air-tight seat to the furnace tube 702 while allowing easy access to the inside of the furnace tube 702. The interlock assembly 706 includes the interlock body 708, the furnace tube flange 709 that serves to couple the interlock body 708 to the furnace tube 702, and the cap 710 that can be used to provide an air-tight seal to the furnace tube 702 and that can be removed to allow access to the inside of the furnace tube 702. The furnace tube flange 709 may be connected to the interlock body 708 via one or more fasteners, welding, or another suitable joining technique.

The interlock body 708 can include four openings. A first opening may include the cap 710 inserted therein. A second opening may receive a portion of the furnace tube 702 including the open end 702b. A third opening 714 can be used to couple the interlock body 708 to a vacuum source, while a fourth opening (not shown) can be used to couple the interlock body 708 to a vacuum sensor.

In the embodiment shown in FIG. 8, an air-tight seal is provided between the furnace tube 702 and the furnace tube flange 709 by virtue of a pair of seal elements 774 and 776 (e.g., o-rings) that interpose between the furnace tube 702 and the furnace tube flange 709. Likewise, an air-tight seal is provided between the furnace tube flange 709 and the interlock body 708 by virtue of a pair of seal elements 770 and 772 (e.g., o-rings) that interpose between the furnace tube flange 709 and the interlock body 708.

It is noted that the furnace system 700 is merely one of many suitable furnaces for annealing the refractory-metal articles disclosed herein. Other vacuum-tube furnaces may be employed.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method of laser cutting, comprising:
disposing a first refractory-metal article in a chamber of a laser cutting apparatus;
drawing a partial vacuum in the chamber having the first refractory-metal article disposed therein; and
laser cutting the first refractory-metal article under the partial vacuum to form a second refractory-metal article.

2. The method of claim 1, wherein drawing the partial vacuum in the chamber having the first refractory-metal article disposed therein includes drawing the partial vacuum to a sufficient vacuum level so that hydrogen embrittlement does not occur in the first refractory-metal article during and/or after the act of laser cutting.

3. The method of claim 1, wherein drawing the partial vacuum in the chamber having the first refractory-metal article disposed therein includes drawing the partial vacuum to a vacuum level of about 25 torr to about 10⁻¹² torr in pressure.

4. The method of claim 3, wherein the vacuum level is about 10⁻³ torr to about 10⁻⁷ torr.

5. The method of claim 1, wherein the second refractory-metal article is configured as an implantable stent.

6. The method of claim 1, wherein the first refractory-metal article comprises a material selected from the group consisting of tantalum, niobium, tungsten, and alloys thereof.

7. The method of claim 1, wherein the first refractory-metal article comprises:
(a) about 0.1 to 70 weight percent niobium;
(b) about 0.1 to 30 weight percent of at least one element selected from the group consisting of tungsten, zirconium, and molybdenum;
(c) up to 5 weight percent of at least one element selected from the group consisting of hafnium, rhenium, and cerium; and
(d) tantalum.

8. The method of claim 1, wherein the first refractory-metal article comprises a tantalum alloy, comprising:
about 75 to about 80 weight percent tantalum;
about 8 to about 12 weight percent niobium; and
about 7 to about 10 weight percent tungsten.

9. The method of claim 9, wherein the first refractory-metal article exhibits at least one of a tungsten content of about 0.1 to about 15 weight percent, a zirconium content of about 0.1 to about 10 weight percent, or a niobium content of about 5 to about 25 weight percent.

10. The method of claim 1, wherein the first refractory-metal article comprises a tantalum alloy, comprising:
about 75 to about 90 weight percent tantalum;
about 8 to about 12 weight percent niobium; and
about 2 to about 10 weight percent tungsten.

11. A method for finishing a refractory-metal, comprising:
providing a first refractory-metal article that includes one or more regions affected by at least one manufacturing process, the one or more regions including at least one of a heat-affected zone, dross, a slag, an oxide-rich zone, an island, a burr, or a score mark; and
finishing the first refractory-metal article to remove the one or more regions therefrom affected by the at least one manufacturing process to form a finished second refractory-metal article.

12. The method of claim 11, wherein providing a first refractory-metal article that includes one or more regions affected by at least one manufacturing process includes forming the first refractory-metal article using at least one of drawing, laser cutting, or laser cutting under partial vacuum conditions.

13. The method of claim 11, wherein the finished second refractory-metal article is configured as an implantable device.

14. The method of claim 11, wherein finishing the first refractory-metal article to remove the one or more regions therefrom affected by the at least one manufacturing process to form the finished second refractory-metal article includes mechanically finishing the first refractory-metal article to produce the finished second refractory-metal article.

15. The method of claim 14, wherein mechanically finishing the first refractory-metal article to produce the finished second refractory-metal article includes honing the first refractory-metal article using an abrasive tool.

16. The method of claim 14, wherein mechanically finishing the first refractory-metal article to produce the finished second refractory-metal article includes:
disposing the first refractory-metal article between a plurality of rollers of a blasting apparatus; and
rotating at least one of the plurality of rollers while blasting the first refractory-metal article with abrasive particles.

17. The method of claim 11, wherein finishing the first refractory-metal article to remove one or more regions therefrom affected by at least one manufacturing process to form a finished second refractory-metal article includes chemically treating the first refractory-metal article.

18. The method of claim 17, wherein chemically treating the first refractory-metal article includes exposing the first refractory-metal article to an acid that includes hydrofluoric acid.

19. The method of claim 11, further comprising annealing the finished second refractory-metal article in a furnace under a partial vacuum.

20. The method of claim 11, wherein the first refractory-metal article comprises a material selected from the group consisting of tantalum, niobium, tungsten, and alloys thereof.

21. The method of claim 11, wherein providing a first refractory-metal article that includes one or more regions affected by at least one manufacturing process includes laser cutting the first refractory-metal article under partial vacuum conditions.

22. A honing apparatus configured for honing a tantalum-based refractory metal implantable article in order to remove one or more regions therefrom affected by at least one manufacturing process, the one or more regions including at least one of a heat-affected zone, dross, a slag, an oxide-rich zone, an island, a burr, or a score mark, the honing apparatus comprising:
an abrasive file that is dimensioned to be inserted into an interior passageway of the implantable article;
a motor structure configured for gripping and rotating the abrasive file;
an arrester configured for holding the file in a substantially straight orientation; and
a roller positioned and configured to bias interior surfaces defining the interior passageway of the implantable article against the file.

23. A blasting apparatus configured for blasting an implantable, the blasting apparatus comprising:
a support structure;
at least one blasting nozzle mounted to the support structure, the blasting nozzle being configured to direct high-velocity abrasive particles from a source of said particles toward an implantable article;
a roller assembly disposed on the support structure, the roller assembly being configured to cradle, position, and rotate the implantable article under the at least one blasting nozzle; and
a plurality of biasing elements operatively coupled to the support structure and the roller assembly, the biasing elements being configured to provide a selected amount of compressive pressure to the implantable article disposed in between the rollers,
wherein the blasting apparatus is configured for blasting an inner diameter surface and an outer diameter surface of the implantable article.

24. The blasting apparatus recited in claim 23, further comprising a motor structure coupled to at least one of the rollers, the motor structure being configured for rotating the implantable article disposed in between the rollers.

25. The blasting apparatus recited in claim 23, wherein the implantable article is a stent.

26. The blasting apparatus recited in claim 23, wherein the blasting apparatus is configured for simultaneously blasting more than one stent.

27. The blasting apparatus recited in claim 25, wherein the stent is blasted in a compressed state, a partially expanded state, or an expanded state.

28. The blasting apparatus recited in claim 25, wherein the stent has an outer diameter of about 1 mm to about 10 mm.

29. The blasting apparatus recited in claim 25, wherein the stent has an outer diameter of about 1 mm to about 6 mm.

30. The blasting apparatus recited in claim 25, wherein the stent has an outer diameter of about 1 mm to about 4 mm.

31. The blasting apparatus recited in claim 23, wherein the blasting apparatus is configured to remove one or more regions from the implantable article affected by at least one manufacturing process, the one or more regions including at least one of a heat-affected zone, dross, a slag, remelt, an oxide-rich zone, an island, a burr, or a score mark.

32. The blasting apparatus recited in claim 23, wherein the blasting apparatus is configured for simultaneously blasting an inner diameter surface and an outer diameter surface of the implantable article.

33. A method for manufacturing an implantable medical device, comprising:
providing a first refractory-metal article, the first refractory-metal article including a material selected from the group consisting of tantalum, niobium, tungsten, and alloys thereof;
disposing the first refractory-metal article in a chamber of a laser cutting apparatus;
drawing a partial vacuum in the chamber having the first refractory-metal article disposed therein to a vacuum level of about 25 torr to about 10⁻¹² torr in pressure such that hydrogen embrittlement does not occur in the first refractory-metal article during and/or after the laser cutting;
laser cutting the first refractory-metal article under the partial vacuum to form a second refractory-metal article;
mechanically and/or chemically finishing the second refractory-metal article to remove one or more regions therefrom affected by at least one manufacturing process using at least one of honing, blasting, thermal blasting, chemically etching, or electropolishing,
the one or more regions affected by the at least one manufacturing process including at least one of a heat-affected zone, a slag, islands, burrs, or score marks; and
annealing the mechanically and/or chemically finished second refractory-metal article to yield the implantable medical device.
